(19) United States
(12) Patent Application Publication
(10) Pub. No.: US 2021/0394818 A1
(43) Pub. Date: Dec. 23, 2021

(54) STEERING MECHANISM FOR AUTONOMOUS VEHICLE

(71) Applicant: Schaeffler Technologies AG & Co. KG, Herzogenaurach (DE)

(72) Inventors: Michael Zinnecker, Berkley, MI (US); Renato de Paula, Sterling Heights, MI (US); Dieter Adler, Schönwald (DE)

(73) Assignee: Schaeffler Technologies AG & Co. KG, Herzogenaurach (DE)

(21) Appl. No.: 16/907,460

(22) Filed: Jun. 22, 2020

(51) Int. Cl. B62D 5/04; B62D 3/08

(52) U.S. Cl. CPC B62D 5/0448; F16H 25/2204; B62D 3/08

(57) ABSTRACT

A steering system for an autonomous vehicle or a steer-by-wire vehicle is simpler than a rack and pinion mechanism. The pinion is replaced by a roller and the toothed portion of the rack is replaced by a flat section. The bar, which replaces the rack is translated along its axis by an electric actuator such as a ball screw. The roller and a yoke prevent out of axis movement and prevent rotation about the axis.

### TECHNICAL FIELD

The disclosure relates to a vehicle steering mechanism. More particularly, the disclosure relates to a steering mechanism that does not include a rack and pinion.

### BACKGROUND

FIG. 1 is a top view of a vehicle steering system. A driver commands steering by rotating a steering wheel 10 connected to a shaft 12. This causes a bar 14 to translate. Left and right wheels 16 and 18 are supported for rotation with respect to left and right knuckles 20 and 22 respectively. (Left and right are from a driver's perspective.) Knuckles 20 and 22 are supported to pivot about vertical axes 24 and 26 respectively. The knuckles may be supported in a manner that allows vertical translation with respect to vehicle structure to improve ride quality. The knuckles are attached to the bar by connecting rods 28 and 30.

FIG. 2 illustrates the condition of the steering system when the vehicle is turning. In response to rotation of the steering wheel, bar 14 has translated toward to left wheel. The back part of left knuckle 20 has been pushed outward while the back part of right knuckle 22 has been pulled inward. This has caused the knuckles to pivot and to re-orient the wheel axes.

FIG. 3 shows the actuator that links bar 14 with shaft 12. A pinion gear 32 fixed to the end of shaft 12 meshes with gear teeth 34 on a section of bar 14. (This toothed portion of the bar may be called a rack.) This meshing interface causes bar 14 to translate in response to rotation of pinion 32. A motor 36 provides assistance, reducing the effort required to turn the steering wheel. Motor 36 is driveably connected to a ball screw drive 38 by belt 40. Ball screw drive 38 interfaces with a threaded section 42 of the bar 14 such that bar 14 translates along its axis in response to rotation of ball screw drive 38 about the axis. A controller commands the motor to provide assistance in response to a torque sensor indicating torsion on shaft 12.

FIG. 4 shows the actuator as seen from the front of the vehicle. A yoke 44 supports bar 14 opposite the pinion gear 32, preventing the toothed portion of the bar from translating downwardly or fore and aft. The pinion gear 32 prevents the toothed portion of the bar from translating upwardly. The pinion gear 32 also prevents rotation of the bar 14 about its axis.

### SUMMARY

A vehicle steering system includes a bar, an actuator, a roller, and a yoke. The bar has an anti-rotation section. The anti-rotation section has a flat surface. The bar is adapted for pivotable connection to a respective connecting rod at each end. The actuator is configured to translate the bar along a bar axis in response to rotation of an electric motor. The roller is in rolling contact with the flat surface to prevent rotation of the bar about the bar axis and limit deflection of the bar. The yoke contacts the bar opposite the roller to prevent translation of the bar perpendicular to the bar axis. The actuator may include a ball nut engaging a threaded portion of the bar via rollers such that rotation of the ball nut results in translation of the bar. The bar may not have a toothed section configured to mesh with a pinion gear. The bar may slide with respect to the yoke.

An actuator is suitable for a vehicle steering system which includes two knuckles, two wheels, and two connecting rods. Each of the two knuckles is supported to pivot about respective vertical axes and each defines respective wheel axes. Each if the two wheels is supported for rotation about a respective one of the wheel axes. Each of the two connecting rods is pivotably connected to a respective knuckle. The actuator includes a bar, a roller, and a yoke. The bar is pivotably connected to the two connecting rods. The bar has an anti-rotation section. The anti-rotation section has a flat surface. The roller contacts the flat surface to prevent rotation of the bar about a bar axis. The yoke contacts the bar opposite the roller to prevent translation of the bar perpendicular to the bar axis. The actuator may also include a motor driveably connected to a ball screw drive. The ball screw drive engages a threaded section of the bar to translate the bar along the bar axis in response to operation of the motor. The actuator may also include a belt driveably connecting the motor to the ball screw drive. The bar may not have a toothed section configured to mesh with a pinion gear.

A vehicle steering system includes a bar, a ball screw, a roller, and a yoke. The bar has a threaded section and an anti-rotation section. The anti-rotation section has a flat surface. The ball screw drive engages the threaded section to translate the bar along a bar axis. The roller contacts the flat surface to prevent rotation of the bar about the bar axis. The yoke contacts the bar opposite the roller to prevent translation of the bar perpendicular to the bar axis. The bar may slide with respect to the yoke. The bar may not have a toothed section configured to mesh with a pinion gear. The steering system may also include a motor driveably connected to the ball screw drive, for example by a belt. The steering system may also include a first knuckle and a first connecting rod. The first knuckle is configured to pivot about a first vertical axis. The first knuckle defines a first wheel axis. The first connecting rod pivotably connects at a first rod end to a first end of the bar and pivotably connected at a second rod end to the knuckle. A first wheel may be supported for rotation about the first wheel axis. The steering system may also include a second knuckle and a second connecting rod. The second knuckle is configured to pivot about a second vertical axis. The second knuckle defines a second wheel axis. The second connecting rod is pivotably connected at a third rod end to a second end of the bar and pivotably connected at a fourth rod end to the second knuckle. A second wheel may be supported for rotation about the second wheel axis.

### BRIEF DESCRIPTION OF THE DRAWINGS

FIG. 1 is a top view of a vehicle steering system shown while not turning.

FIG. 2 is a top view of the vehicle steering system of FIG. 1 shown while turning.

FIG. 3 is a top view of a portion of the vehicle steering system of FIG. 1.

FIG. 4 is a front view of the portion of the vehicle steering system of FIG. 1.

FIG. 5 is a rear view of a portion of a vehicle steering system for an autonomous vehicle.

FIG. 6 is an end view of the portion of the vehicle steering system of FIG. 5.

FIG. 7 is pictorial view of the portion of the vehicle steering system of FIG. 5.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

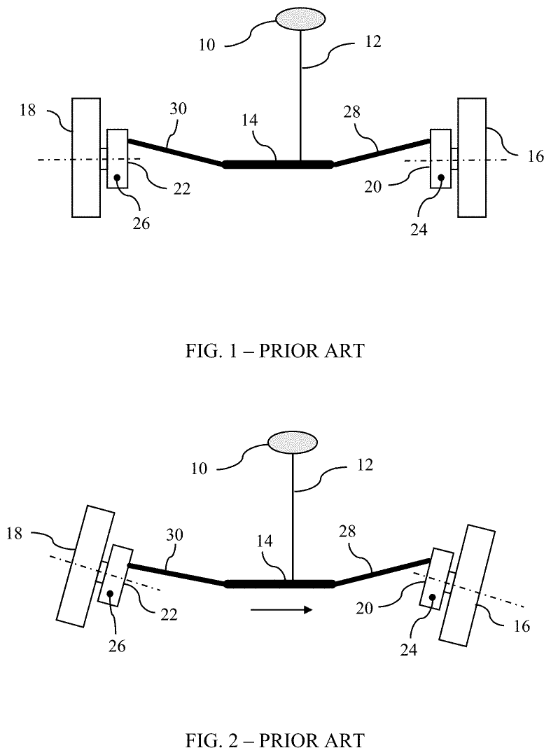

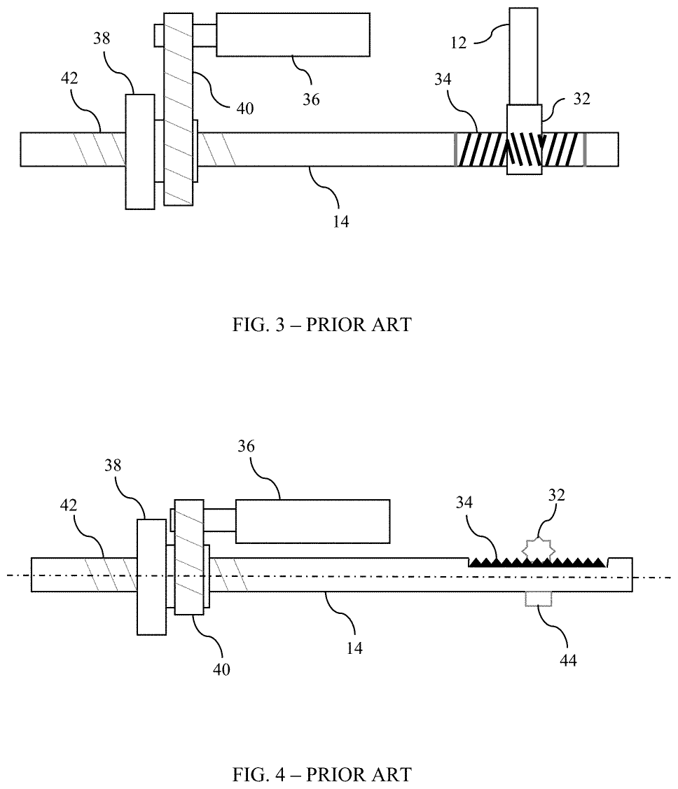

Autonomous vehicles are steered by a control unit as opposed to a human driver. Therefore, the steering wheel 10 and shaft 12 of FIGS. 1-4 are not needed. In an autonomous vehicle application, motor 36 provides primary steering as opposed to merely an assist. In a steer-by-wire vehicle, the shaft 12 may be omitted and the control unit directs motor 36 in response to driver rotation of the steering wheel. However, the pinion 32 and toothed section of rod 34 cannot simply be omitted because they serve an additional function beyond converting rotation of shaft 12 to translation of bar 14. If the pinion 32 were simply omitted, bar 14 might rotate with ball screw drive 38 instead of translating. These features also offer bending support to the rack when forces from tie rods are transferred through the steering system.

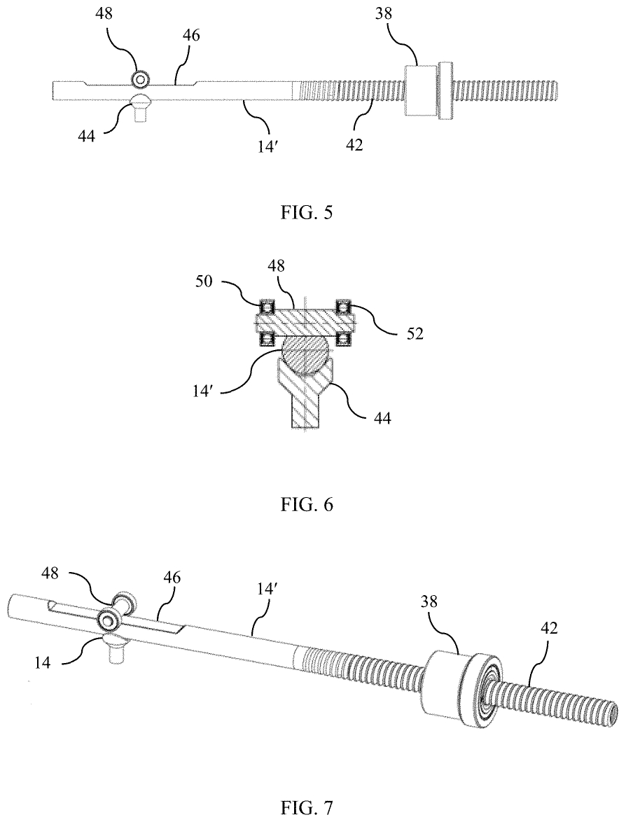

FIGS. 5-7 illustrate a steering mechanism actuator suitable for an autonomous vehicle. Parts which are identical to corresponding parts in FIGS. 1-4 are labeled with the same reference number. Parts which are similar but not identical are labeled with a primed reference number. FIG. 5 shows the actuator from the rear. FIG. 6 is a cross section through the yoke 44. FIG. 7 is a pictorial view.

Bar 14′ does not have a toothed section. Instead, it has a flat section 46. A roller 48 is supported in place of the pinion gear and is in rolling contact with flat section 46. As shown in FIG. 6, roller 48 is supported by two ball bearings 50 and 52. No input torque is supplied to the roller. Roller 48 serves two functions. First, it prevents bat 14 from deflecting excessively. Second, it prevents bar 14 from rotating. The yoke illustrated in FIGS. 5-7 is a sliding contact type of yoke.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle steering system comprising:
a bar having an anti-rotation section, the anti-rotation section having a flat surface, the bar adapted for pivotable connection to a respective connecting rod at each end;
an actuator configured to translate the bar along a bar axis in response to rotation of an electric motor;
a roller in rolling contact with the flat surface to prevent rotation of the bar about the bar axis and limit deflection of the bar; and
a yoke contacting the bar opposite the roller to prevent translation of the bar perpendicular to the bar axis.

2. The vehicle steering system of claim 1 wherein the actuator comprises a ball nut engaging a threaded portion of the bar via rollers such that rotation of the ball nut results in translation of the bar.

3. The vehicle steering system of claim 1 wherein the bar does not have a toothed section configured to mesh with a pinion gear.

4. The vehicle steering system of claim 1 wherein the bar slides with respect to the yoke.

5. An actuator for a vehicle steering system, the vehicle steering system comprising:
two knuckles, each supported to pivot about respective vertical axes and each defining respective wheel axes;
two wheels, each supported for rotation about a respective one of the wheel axes; and
two connecting rods, each pivotably connected to a respective knuckle;
the actuator comprising:
a bar pivotably connected to the two connecting rods and having an anti-rotation section, the anti-rotation section having a flat surface;
a roller contacting the flat surface to prevent rotation of the bar about a bar axis; and
a yoke contacting the bar opposite the roller to prevent translation of the bar perpendicular to the bar axis.

6. The actuator of claim 5 further comprising a motor driveably connected to a ball screw drive, the ball screw drive engaging a threaded section of the bar to translate the bar along the bar axis in response to operation of the motor.

7. The actuator of claim 6 further comprising a belt driveably connecting the motor to the ball screw drive.

8. The actuator of claim 5 wherein the bar does not have a toothed section configured to mesh with a pinion gear.

9. A vehicle steering system comprising:
a bar having a threaded section and an anti-rotation section, the anti-rotation section having a flat surface;
a ball screw drive engaging the threaded section to translate the bar along a bar axis;
a roller contacting the flat surface to prevent rotation of the bar about the bar axis; and
a yoke contacting the bar opposite the roller to prevent translation of the bar perpendicular to the bar axis.

10. The vehicle steering system of claim 9 further comprising a motor driveably connected to the ball screw drive.

11. The vehicle steering system of claim 10 further comprising a belt driveably connecting the motor to the ball screw drive.

12. The vehicle steering system of claim 10 further comprising:
a first knuckle configured to pivot about a first vertical axis, the first knuckle defining a first wheel axis; and
a first connecting rod pivotably connected at a first rod end to a first end of the bar and pivotably connected at a second rod end to the knuckle.

13. The vehicle steering system of claim 12 further comprising a first wheel supported for rotation about the first wheel axis.

14. The vehicle steering system of claim 12 further comprising:
a second knuckle configured to pivot about a second vertical axis, the second knuckle defining a second wheel axis; and
a second connecting rod pivotably connected at a third rod end to a second end of the bar and pivotably connected at a fourth rod end to the second knuckle.

15. The vehicle steering system of claim 14 further comprising:
a first wheel supported for rotation about the first wheel axis; and
a second wheel supported for rotation about the second wheel axis.

16. The vehicle steering system of claim 9 wherein the bar does not have a toothed section configured to mesh with a pinion gear.

17. The vehicle steering system of claim 9 wherein the bar slides with respect to the yoke.
